(19) United States
(12) Patent Application Publication
(10) Pub. No.: US 2003/0147305 A1
(43) Pub. Date: Aug. 7, 2003

(54) Inexhaustible prime mover

(76) Inventor: Alan David Kenney, Marford (GB)

Correspondence Address: Russell D. Orkin, WEBB ZIESENHEIM LOGSDON ORKIN & HANSON, P.C., 700 Koppers Building, 436 Seventh Avenue, Pittsburgh, PA, 15219-1818, US

(21) Appl. No.: 10/317,008

(22) Filed: Dec. 11, 2002

Related U.S. Application Data
(63) Continuation of application No. 09/719,953, filed on Feb. 15, 2001, now abandoned.
Application No. 09/719,953 is a 371 of international application No. PCT/GB99/01917, filed on Jun. 16, 1999.

(30) Foreign Application Priority Data
Jun. 18, 1998 (GB) 9813173.3

(51) Int. Cl. F03B 17/00

(52) U.S. Cl. 366/349; 415/916

(57) ABSTRACT

Apparatus for providing motive power comprises first and second communicating columns (10, 14) of liquid, the liquid in the second column being substantially the same as in the first column but containing a finely divided material to increase its specific gravity relative to the liquid in the first column, means (28) for maintaining the finely divided material in suspension in the second column, whereby liquid height in the respective columns is different, so that liquid from the first column overflows into the second column, means for converting energy from resultant movement of liquid into motive power and means (26) for returning the liquid to the first column.

### DESCRIPTION

This invention concerns a method and apparatus for providing motive power. in WO91/09224 there is described apparatus for providing motive power comprising first and second columns of liquid, the liquid in the second column being substantially the same as in the first column but containing a finely divided material to increase its specific gravity relative to the liquid in the first column, means for reducing pressure above said columns, whereby liquid height in the respective columns is different, means for causing liquid from the first column to overflow into the second column, means for converting energy from resultant movement of liquid into motive power and means for returning liquid to the first column.

It was found that the means for reducing pressure above the columns was not really necessary and a second apparatus was proposed in WO92/1984, wherein that feature was omitted. The apparatus in WO92/1984 required a pump to maintain the finely divided material in suspension. However, that apparatus did not operate successfully because of the energy consumed in operating the pump.

An object of this invention is to provide improved method and apparatus for providing motive power.

According to a first aspect of the invention there is provided apparatus for providing motive power comprising first and second communicating columnns of liquid, the liquid in the second column being substantially the same as in the first column but containing a finely divided material to increase its specific gravity relative to the liquid in the first column, means for maintaining the finely divided material in suspension in the second column, whereby liquid height in the respective columns is different, so that liquid from the first column overflows into the second column, means for converting energy from resultant movement of liquid into motive power, means for returning the liquid to the first column, and liquid agitating means associated with the second column, wherein the agitating means comprises at least one propeller or impeller.

According to a second aspect of the invention there is provided a method of providing motive power comprising the steps of providing in a first column a liquid and in a second column the same liquid but containing a finely divided material to increase its specific gravity relative to the liquid in the first column, maintaining the finely divided material in suspension in the second column, the two columns communicating whereby liquid height in the respective columns is different, so that liquid from the first column overflows into the second column, converting energy from resultant movement of liquid into motive power and returning the liquid to the first column, wherein the means for converting energy from liquid movement into motive power is a turbine.

Thus the invention provides a circulatory system for providing motive power. Overflow of liquid from the first to the second columns may be controlled by a valved outlet located below the level at which the first column would be in dynamic balance with the second column. It is preferred to keep the finely divided material substantially evenly dispersed throughout the liquid in the second column. It may be advantageous to have two or more propellers or impellers at different heights in the column.

The turbine may be located at any point in the apparatus where movement of the liquid only can be utilised. In one preferred embodiment the turbine may be associated with the second column for failing liquid to impinge directly on rotating blades thereof. In another preferred embodiment the turbine may be associated with the first column itself to be driven by liquid rising or pressurised in that column.

The second column preferably has a second limb communicating with the main column from just below the turbine to a part of the of column, which limb may include said agitating means to provide circulatory motion for the liquid in the second and hence even dispersion of the finely divided material therein.

The second column is preferably taller than its width, to minimise mixing energy requirements. Preferably two or more agitators will be used spaced apart on a single shaft for achieving suspension of the finely divided material.

The preferred finely divided material is one that can readily be separated from the liquid in the second column so that the liquid only can be returned from the second column to the first column. Possibly the finely divided material may be of a magnetic substance such as magnetite or ferrosilicon or a mixture of both, so that magnetic means may be used to remove or hold back the finely divided material from the liquid being returned to the first column. Alternatively, mechanical separation means may be used such as filter means or a settling tank. The finely divided material is preferably of a particle size that will pass a 0.25 mm mesh.

The design of settling vessel needs careful consideration as the rate of suspension separation may determine the maximum system liquid flow, and hence energy available to the turbine. An outwardly conically shaped vessel is adequate but settling rates can be improved by installing suitable baffle plates to induce longer flow paths for the suspension, and hence longer residence time for the separation phase to take place. The angle of the outer wall of a cone shaped vessel may be significant in facilitating settlement. Angles of at least 70° to the horizontal are believed to be desirable. Alternatively, appropriately sized filter screens can be employed in the second column or an associated vessel or vessels to achieve the phase separation of the suspension. Vibration of these screens may be desirable to minimise blinding and maximise separation rates. Suitable vibration devices may be mounted in an airlock at the upper end of the second column and motive power provided by small turbines operated from pressurised liquid in the first column. A further energy efficient method that may be employed either alone or in conjunction with other separation methods is to direct the suspension flow within the settling vessel through a weakly magnetic field, which has the effect of agglomerating the individual magnetic particles together, into heavier clusters, which causes them to sink faster, speeding up the separation process.

Separation areas ideally will be minimised otherwise commercial scale separation requirements may be too great. Therefore, it is further proposed that tilted tube settling devices be used. Such tubes are commercially available and can reduce the area required for gravity settling by about 50% without substantial pressure loss.

An alternative separation method for use in the apparatus of the invention may be to use cyclone separation.

It is believed that the apparatus is able to produce a surplus of output energy from gravitational force greater than the energy required for its sustained operation. Liquids of different densities are used in the respective first and second columns. The liquids are freely miscible with each other and are used to establish the different levels between the first and second columns. It is this difference in levels that gives the separated water its potential energy relative to the media in the second or mixing column.

The use of finely divided material enables the necessary height differential between the first and second columns to be established. The miscible properties of the suspension of finely divided materials and the liquid in the first column enable continuous flow conditions within the apparatus to be maintained. The separation of the clear liquid from the finely divided material is achieved by using gravity again, to settle out the material.

By connecting the higher liquid column to the top of the second or mixer column a flow rate can be established to convert potential energy into useful power by a water turbine.

The off-take pipe is always located below the dynamic balance level of the liquid column to ensure that the system cannot balance and stop. Gravity acting equally on each column will cause liquid to move upwards in the first column as the liquids attempt to rebalance. It is this continuous upwards displacement of the lighter liquid in the first column that maintains the height differential between the two columns and provides the energy output.

The apparatus requires comparatively small amounts of energy to circulate and maintain the finely divided material in suspension within the second column. The net energy output from the apparatus is the energy available at the turbine shaft, less the energy required to maintain the finely divided material in suspension. The apparatus of the invention does not contravene the first and second laws of thermodynamics. The energy produced is significantly less than the total gravitational force input.

This invention will now be further described by way of example only, with reference to the accompanying drawings, in which:—

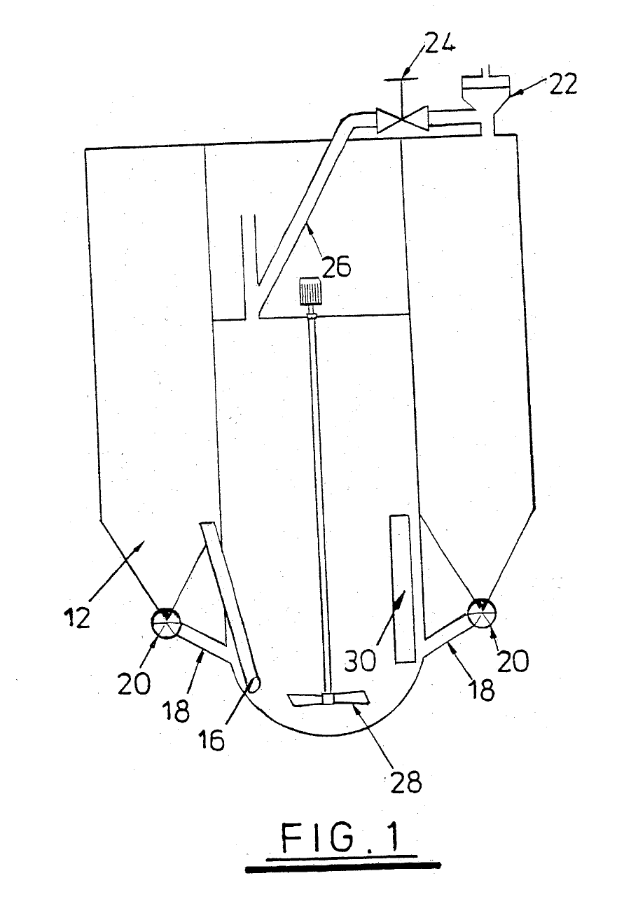

FIG. 1 is a schematic representation of apparatus according to the invention;

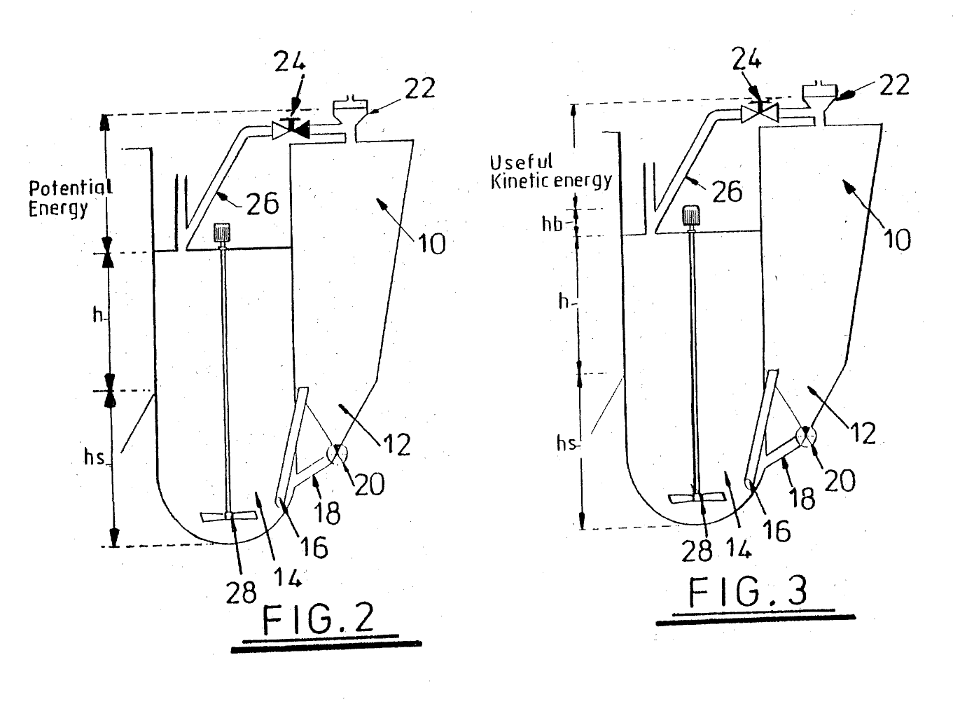

FIGS. 2 and 3 show the apparatus of FIG. 1 in operation;

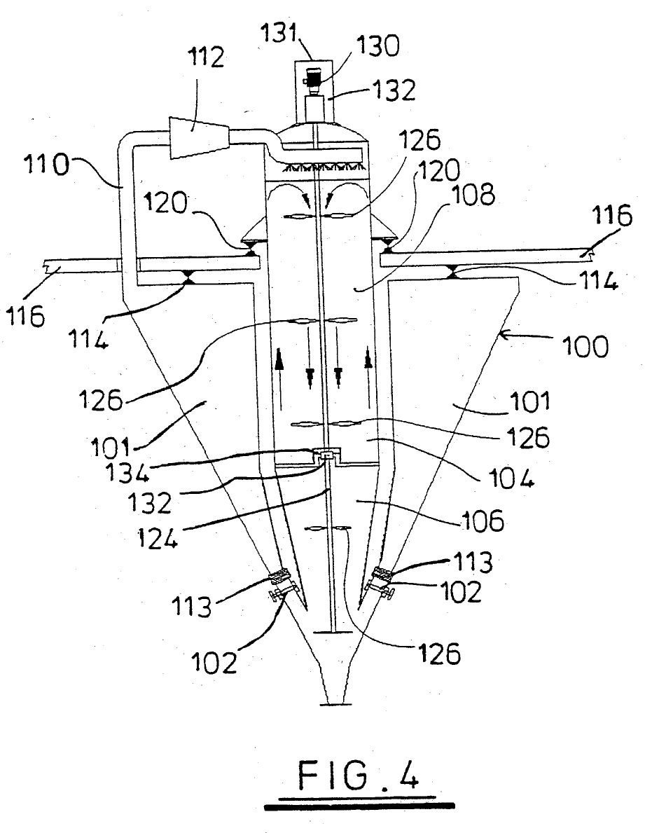

FIG. 4 shows schematically an alternative embodiment of the invention;

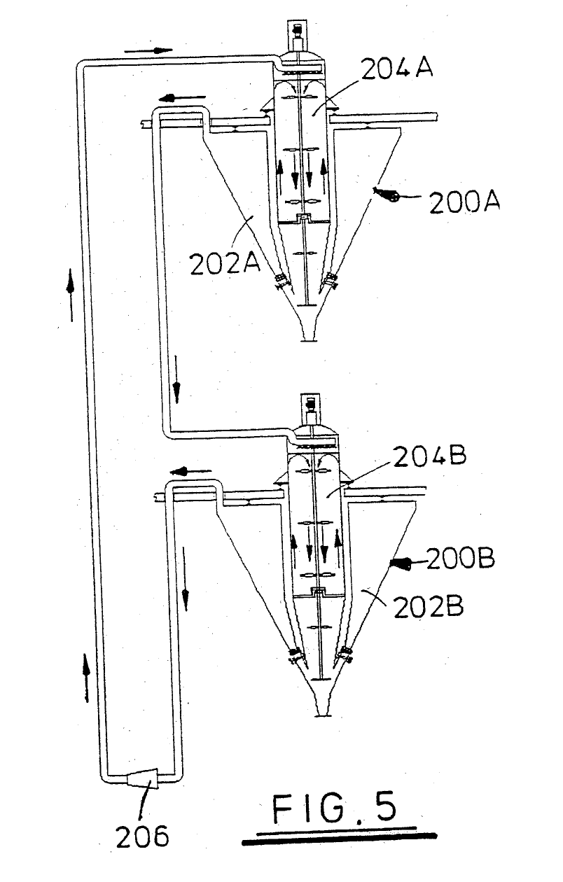

FIG. 5 shows schematically coupling of apparatus of the invention; and

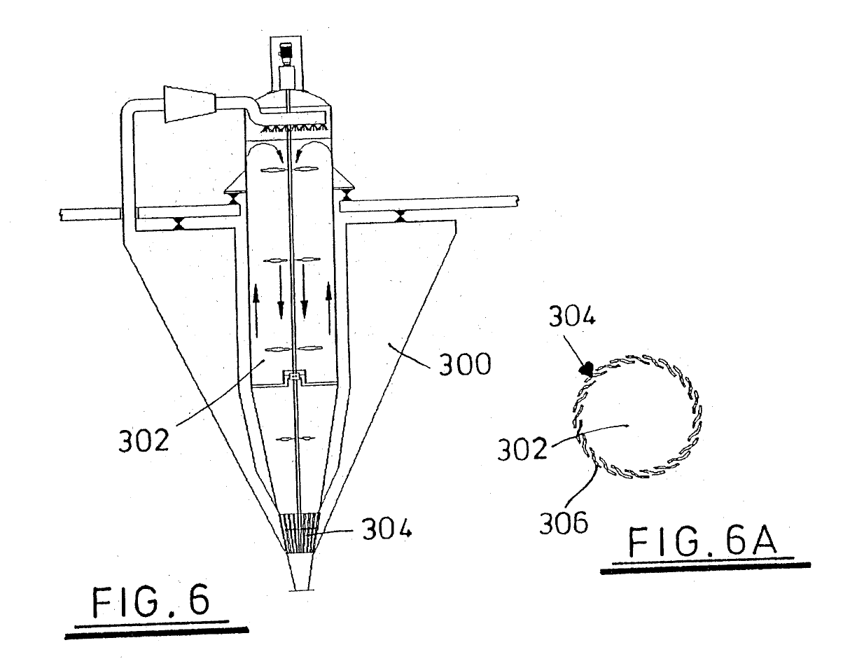

FIG. 6 shows a variation on the embodiment of FIG. 4.

Referring to FIGS. 1 to 3 of the accompanying drawings, apparatus for providing motive power comprises a first column 10 in the form of an annular tank having flared sides and a base formed as a plurality of cone shaped separating zones 12 and a second column 14 surrounded by the first column 10. The first and second columns 10, 14 communicate in three ways. Firstly, a lower region of the second column communicates with a lower region of the first column almost at the top of the cones 12 by means of pipe 16. Secondly at the bottom of the cones 14 there are pipes 18 extending from the cones via rotary valves 20. (Any other suitable valves may be used, such as sock valves). Thirdly, via a header tank 22 and a valve 24 there is a pipe 26 from the top of the first column down to the top of the second column.

The second column 14 contains an aerofoil or propeller type mixer 28 operating in a lower region thereof. The column 14 also includes a plurality of baffle plates 30 spaced around its outer region to promote mixing.

The first column 10 initially contains water and the second column 14 contains water and finely divided magnetite (or any suitable dense medium) in suspension. The suspension is maintained by the mixer 28 operating at a relatively low speed, simply to maintain a mixture of magnetite and water.

Because the two columns are in communication via pipe 16 and the liquids therein have different specific gravities, the water in the first column rises relative to the mixture in the second column. Some magnetite will enter the first column but settles out and is returned to the second column via the rotary valves 20.

As shown in FIG. 2, with the valve 24 closed, the water in the first column rises to a first height. Then when the valve 24 is opened as shown in FIG. 3 water can return to the second column.

Assuming that the valve outlet 24 is positioned below the static level of the liquid in the first column on opening the valve liquid will flow down pipe 26 and a turbine on the pipe (not shown) can extract the energy available from the head pressure times the volume flowing and convert this kinetic energy into shaft power.

The system is now unbalanced and gravity will continue to force the lighter separated water to the top of the first column in an attempt to re-balance the system. Provided the magnetite is maintained in suspension and the rate of separation is maintained within the first vessel 10 the circulation and energy extraction will be constantly maintained.

The foregoing description is simplified for the purpose of initial illustration and basic understanding of the principles involved with the system.

Essentially gravity is providing the turbine motive power as it attempts to re-balance a constantly unbalanced liquid circulatory system and in doing so generates kinetic energy as both liquid head pressure and flow. Gravity is also made to serve a secondary function in effecting the phase separation of the magnetite and liquid, within the first column 10.

Turning to FIG. 4 of the accompanying drawings, apparatus for providing motive power comprises a first column 100 in the form of four quadrant section tanks 101, each communicating via valved connections 102 with the base of a second column 104 around which they are arranged. The tanks 101 together form a generally cone shaped outer surface. The second column or tank 104 has a lower conical portion 106 widening to an upper cylindrical portion 108.

Each tank 101 has a pipe 110 from its upper end communicating with the top of the second column via a turbine 112.

The tanks 101 have flexible bellows type connections 113 to the second tank 104 and are suspended via load cells 114 from rigid supports 116. The second tank is mounted on the rigid supports 116 with load cells 120 therebetween. The load cells 114 and 120 enable the weights of the various tanks to be monitored and hence operating conditions recorded. That can provide a basis for automatic operation control.

The second column contains an aerofoil or propeller type mixer having a shaft 124 and a series of spaced three bladed aerofoils 126 for agitation of the contents of the tank. The shaft is driven by a water motor 130 in an airlock cylinder 131 at the top of the second column to shroud the drive unit and protect it from the media. The shaft is supported intermediate its ends by a bearing 132 supported from sides of the tank and within an airlock 134. Alternatively, an electric motor could be used for driving the shaft.

The first tanks 101 initially contain water and the second tank 104 contains water and finely divided magnetite or ferrosilicon in suspension. The agitation of the aerofoil blades keeps the finely divided material in suspension. The aerofoil blades are designed to urge the suspension downwards drawing a central core of suspended media down to the base of the tank and to flow upwards in the outer regions of the tank. The outer sides of the first tanks slope at an angle of about 70° to the horizontal, so that there is less likelihood of the finely divided material settling on the sides of the tanks.

Because the two tanks are in communication and the liquids therein have different specific gravities, the water in the first tanks rises relative to the media in the second tank. Some of the finely divided material will enter the first tanks but will settle out and return to the second tank via the valved connections. The water rising in the first tanks flows back to the second tank via the turbines thus generating power in the same way as described for the first embodiment.

Experiments have shown that rotating the blades at about 56 rpm is sufficient to pump about 41 m³ of media per minute. The second tank contains about 8 tonnes of magnetite to form a media ranging in density from 2 sg at the base to 1.8 sg at the top of the tank.

The mixer blades can operate adequately using around 750 watts to provide a re-mixing capability of around 5 m³ per minute. With an achieved pressure head of 2.75 metres a turbine output, net of mechanical losses, in excess of 2 Kw may be achieved showing an exportable energy output of around 1.4 Kw. More blades may be fitted to the shaft but that does not seem to require a linear progression in the amount of power drawn.

There will obviously be a limit to the height of any single mixer tank (second column) caused by either loss of media density at the top of the tank or unacceptable power input to maintain fluidisation. Therefore, as shown in FIG. 5 of the accompanying drawings, it is proposed to mount apparatus 200A and 200B of the invention in a vertical series. The apparatus 200 can be of the type shown in FIG. 4, for example. Top apparatus 200A delivers water under pressure from its first column 202A to the second coumn 204B of the bottom apparatus 200B. The water pressure is further increased by the operation of apparatus 200B and the water is then delivered to turbine 206. The turbine is located at ground level for convenience and is of a type designed to extract energy from the difference in the inlet pressure water flow and the back pressure on the discharge.

Finally, in FIGS. 6 and 6A of the drawings, there is shown an alternative to the embodiment of FIG. 4, wherein valved connections between the first (300) and second columns (302) are replaced by having the bottom of the second column louvred (304) to form vertical slots for the finely divided material to return to the base of the second column. The louvres are formed by vanes 306.

1. Apparatus for providing motive power comprising first and second communicating columns of liquid, the liquid in the second column being substantially the same as in the first column but containing a finely divided material to increase its specific gravity relative to the liquid in the first column, means for maintaining the finely divided material in suspension in the second column, whereby liquid height in the respective columns is different, so that liquid from the first column overflows into the second column, means for converting energy from resultant movement of liquid into motive power and means for returning the liquid to the first column.

2. Apparatus as claimed in claim 1, wherein overflow is controlled by a valved outlet located below the level at which the first column would be in dynamic balance with the second column.

3. Apparatus as claimed in claim 1 or 2 further comprising liquid agitating means associated with the second column.

4. Apparatus as claimed in claim 3, wherein the agitating means comprises a propeller or impeller.

5. Apparatus as claimed in claim 4, wherein two or more propellers or impellers are provided at different heights in the column.

6. Apparatus as claimed in any one of claims 1 to 5, wherein the means for converting energy from liquid movement into motive power is a turbine.

7. Apparatus as claimed in claim 6, wherein the turbine is associated with the second column for falling liquid to impinge directly on rotating blades thereof.

8. Apparatus as claimed in claim 6, wherein the turbine is associated with the first column itself to be driven by rising liquid.

9. Apparatus as claimed in claim 6, wherein the second column has a second limb communicating with the second column from just below a turbine to a lower part of the column, which limb includes agitating means to provide circulatory motion for the liquid in the second column.

10. Apparatus as claimed in any one of claims 1 to 9, wherein the second column is taller than its width.

11. Apparatus as claimed in any one of claims 3 to 10, wherein two or more agitators are provided spaced apart on a single shaft for achieving suspension of the finely divided material.

12. Apparatus as claimed in any one of claims 1 to 11, wherein the finely divided material is one that can readily be separated from the liquid in the second column so that the liquid only can be returned from the second column to the first column.

13. Apparatus as claimed in claim 12, wherein the finely divided material is of a magnetic substance.

14. Apparatus as claimed in claim 13, wherein the finely divided material is magnetite or ferrosilicon or a mixture thereof.

15. Apparatus as claimed in any one of claims 1 to 14, further comprising magnetic means for remixing or holding back the finely divided material from the liquid being returned to the first column.

16. Apparatus as claimed in any one of claims 1 to 14 further comprising mechanical separation means for removing the finely divided material from the liquid being returned to the first column.

17. Apparatus as claimed in any one of claims 1 to 16, wherein the finely divided material is of a particle size that will pass a 0.25 mm mesh.

18. Apparatus as claimed in any one of claims 1 to 17 including means associated with the first column for settling out finely divided material in the first column.

19. Apparatus as claimed in claim 18, wherein the first column is in the form of a cone shaped vessel.

20. Apparatus as claimed in claim 19, wherein the angle of the outer wall of a cone shaped vessel is at least 70° to the horizontal.

21. Apparatus as claimed in any one of claims 1 to 17 comprising cyclone separation means for separating the finely divided material from the liquid in the first column.

22. A method of providing motive power comprising the steps of providing in a first column a liquid and in a second column the same liquid but containing a finely divided material to increase its specific gravity relative to the liquid in the first column, maintaining the finely divided material in suspension in the second column, two columns communicating whereby liquid height in the respective columns is different, so that liquid from the first column overflows into the second column, converting energy from resultant movement of liquid into motive power and returning the liquid to the first column.

23. A method as claimed in claim 22, wherein overflow of liquid from the first to second columns is controlled by a valved outlet located below the level at which the first column would be in dynamic balance with the second column.

24. A method as claimed in claim 22 or 23 comprising agitating the liquid in the second column.

25. A method as claimed in claim 22, 23 or 24, wherein the means for converting energy from liquid movement into motive power is a turbine.
